(19) United States
(12) Patent Application Publication
(10) Pub. No.: US 2009/0027507 A1
(43) Pub. Date: Jan. 29, 2009

(54) XY stage and image-taking apparatus

(75) Inventors: Hideo Kobayashi, Saitama (JP); Yukitaka Takeshita, Miyagi (JP); Keiji Ohkubo, Miyagi (JP)

Correspondence Address: BIRCH STEWART KOLASCH & BIRCH, PO BOX 747, FALLS CHURCH, VA, 22040-0747, US

(73) Assignee: FUJINON CORPORATION

(21) Appl. No.: 12/219,045

(22) Filed: Jul. 15, 2008

(30) Foreign Application Priority Data
Jul. 27, 2007 (JP) 2007-196646
Jun. 27, 2008 (JP) 2008-169375

(51) Int. Cl. H04N 5/228

(52) U.S. Cl. 348/208.11; 396/55; 348/E05.031

(57) ABSTRACT

An XY stage includes an X stage and a Y stage. The X stage is supported at three points, i.e., two bearings of a first guide shaft, and a first support shaft. The Y stage is also supported at three points, i.e., two bearings of a third guide shaft, and a second support shaft. A CCD holder, which is a stage to be moved, is also supported at three points, i.e., two bearings of a second guide shaft and one bearing of the first guide shaft. The one bearing supporting the CCD holder is opened in the Y direction to be U-shaped so that the first guide shaft is inserted therein, and the first guide shaft is supported on one side of this U-shaped bearing by receiving a biasing force applied by a spring, so that the attitude of the CCD holder in a predetermined direction is defined.

### BACKGROUND OF THE INVENTION

1. Field of the Invention

The present invention relates to an XY stage that includes a base body and a stage to be moved relative to the base body in an X-Y plane perpendicular to a central axis passing through the base body in a Z direction, and an image-taking apparatus including the XY stage.

2. Description of the Conventional Technique

A shake correcting mechanism is built in an image-taking apparatus in order to suppress occurrence of a blurr in a photographed image caused by user's shake and the like. In the shake correcting mechanism, an optic component, such as a correction lens or an imaging device, is provided to be freely moved in a plane perpendicular to an optical axis. The shake correcting mechanism generally moves the correction lens or the imaging device in accordance with shake, thereby correcting the shake.

An XY stage including X and Y stages disclosed in Japanese Patent Application Publication No. 2006-215095 is widely used to move the optical component.

A voice coil motor having a very high response is used as a driving source in Japanese Patent Application Publication No. 2006-215095 so that each of the stages is driven with a minimum driving force and a stage to be moved can thus be quickly moved in accordance with the shake. Further, Japanese Patent Application Publication No. 2006-215095 proposes the following technique. That is, four guide shafts are provided around an imaging device and X and Y stages are independently driven along the guide shafts so that the stage to be moved can be quickly moved along with the movement of the voice coil motor.

Meanwhile, in Japanese Patent Application Publication No. 2006-215095, four guide shafts are provided so as to surround the stage to be moved, so that the stage to be moved is moved along the four guide shafts. Therefore, the alignment of the four guide shafts needs to be accurately adjusted. However, it is difficult to adjust the alignment of the four shafts individually and to obtain squareness and parallelism between the shafts.

If the alignment of each of four shafts is not accurately adjusted, the X and Y stages and the stage to be moved are not positioned on the same plane. For this reason, the movement of the stage to be moved deteriorates, so that the shake is not accurately corrected. In some cases, the stage to be moved are excessively restricted by the X and Y stages and thus cannot be moved.

In order to avoid such a situation, it may be considered that a dedicated jig used to accurately adjust the alignment of the four shafts is provided to obtain the squareness and parallelism between the four shafts, thereby obtaining flatness of each stage and the stage to be moved. In this case however, since the cost of the dedicated jig and adjustment therefore are required, there is such a problem that manufacturing cost is increased.

### SUMMARY OF THE INVENTION

The present invention has been made in view of the above circumstances and provides an XY stage that is easily assembled while achieving flatness and has low manufacturing cost, and an image-taking apparatus including the XY stage.

An XY stage according to the present invention has a base body, and a stage to be moved relative to the base body in an X-Y plane perpendicular to a central axis passing through the base body in a Z direction, the XY stage includes:

an X stage that surrounds a half of the periphery of the central axis, is supported by the base body so as to freely slide in an X direction, supports the stage to be moved so that the stage to be moved is restricted in the X direction and freely slides in a Y direction, and moves the stage to be moved in the X direction by sliding in the X direction; and

a Y stage that surrounds the entire periphery of the central axis together with the X stage by surrounding a half of the periphery of the central axis, is supported by the base body so as to freely slide in the Y direction, supports the stage to be moved so that the stage to be moved is restricted in the Y direction and freely slides in the X direction, and moves the stage to be moved in the Y direction by sliding in the Y direction,

wherein the X stage is supported at three points by the base body so as to freely slide in the X direction, so that the attitude of the X stage with respect to the base body is defined,

the Y stage is supported at three points by the base body so as to freely slide in the Y direction, so that the attitude of the Y stage with respect to the base body is defined, and

the X and Y stages support the stage to be moved at three points, so that the attitude of the stage to be moved with respect to the base body is defined.

In the XY stage according to the present invention, each of the X and Y stages, which are provided so as to surround the central axis, is supported at three points by the base body. Further, the stage to be moved is supported at three points by the X and Y stages. In general, when an object is supported at three points, one plane is determined. Therefore, the attitude of the X stage is defined so that the plane of the X stage is substantially parallel to the base body, and the attitude of the Y stage is defined so that the plane of the Y stage is substantially parallel to the base body. In addition, the stage to be moved is supported by the X and Y stages of which planes are parallel to the base body. Therefore, the attitude of the stage to be moved is also defined so that the plane of the stage to be moved is substantially parallel to the base body.

For this reason, the alignment of the four shafts does not need to be adjusted unlike in the conventional technique. Accordingly, only simple operations for merely mounting the X and Y stages and then the stage to be moved are required and thus, the XY stage is easily assembled while achieving the flatness of the X and Y stages and the stage to be moved.

Here, this XY stage may further include:

a first guide shaft that extends in the X direction and is fixedly supported by the base body,

wherein the X stage includes two bearings that are supported by the first guide shaft so as to be restricted in the Y direction and freely slide in the X direction, and a first support shaft that protrudes in the X direction and is supported by the base body so as to freely slide in the X direction, and

the X stage is supported at three points, that is, the two bearings supported by the first guide shaft and the first support shaft supported by the base body, so that the attitude of the X stage with respect to the base body is defined.

Further, the XY stage may include:

a second guide shaft that extends in the X direction and is fixedly supported by the Y stage,

wherein the stage to be moved includes two bearings that are supported by the second guide shaft so as to be restricted in the Y direction and freely slide in the X direction, and one bearing that is supported by the first guide shaft not to be restricted in both X and Y directions, and

the stage to be moved is supported at three points, that is, the two bearings supported by the second guide shaft and the bearing supported by the first guide shaft, so that the attitude of the stage to be moved with respect to the base body is defined.

In this case, the X stage is supported at three points, that is, two bearings that are supported by the first guide shaft so as to be restricted in the Y direction and freely slide in the X direction, and the first support shaft that is supported by the base body. Accordingly, the X stage is supported by the base body so that the plane of the X stage is substantially parallel to the plane of the base body.

Further, the stage to be moved is supported at three points, that is, two bearings that are supported by the second guide shaft so as to be restricted in the Y direction and freely slide in the X direction, and one bearing that is supported by the first guide shaft not to be restricted in both X and Y directions. Therefore, the stage to be moved is not excessively restricted by the X stage, and is supported so as to be substantially parallel to the plane of the base body.

Here, the bearing of the stage to be moved, which is supported by the first guide shaft, is preferably opened in the Y direction to have the shape of a U groove with the first guide shaft therein.

If the bearing of the stage to be moved, which is supported by the first guide shaft, has the shape of a U groove opened in the Y direction, for example, when the first guide shaft is biased against one side of the U groove by a biasing force of a biasing member, it is possible to maintain the attitude of the stage to be mounted in the Z direction.

Preferably, the XY stage further includes:

a third guide shaft that extends in the Y direction and is fixedly supported by the X stage,

wherein the stage to be moved includes a bearing which is supported by the third guide shaft so as to be restricted in the X direction and freely slide in the Y direction, and which is supported not to be restricted, for defining the attitude of the stage to be moved.

The stage to be moved is already supported at three points, so that the plane with respect to the base body is determined. Therefore, if another bearing is provided as described above so as to restrict the attitude of the stage to be moved in the Z direction, the stage to be moved is excessively restricted at four points. Meanwhile, if the bearing is allowed not to restrict the attitude of the stage to be moved in the Z direction, it is possible to more stably support the stage to be moved. In addition, if the bearing is provided at a position where moments generated in the stage to be moved can be supported by the forces from the driving points of the X and Y stages while the stage to be moved is moved due to the driving of the X and Y stages, the movement of the stage to be moved becomes more stable. That is, it is possible to prevent the backlash in the X direction while the stage to be moved is moved.

In the structure of the bearing that unrestricted supports the stage to be moved, the bearing of the stage to be moved, which is supported by the third guide shaft, maybe opened in the Z direction so as to have the shape of a U groove with the third guide shaft therein.

The bearing supported by the third guide shaft is opened in the Z direction so that the third guide shaft is fitted therein to, thereby easily forming a bearing that prevents the stage to be moved from being supported at four points and supports the stage to be moved so that the attitude thereof is not restricted in the Z direction.

Also, preferably, the XY stage further includes:

a fourth guide shaft that extends in the Y direction and is fixedly supported by the base body,

wherein the Y stage includes two bearings that are supported by the fourth guide shaft so as to be restricted in the X direction and freely slide in the Y direction, and a second support shaft that protrudes in the Y direction and is supported by the base body so as to freely slide in the Y direction, and

the Y stage is supported at three points, that is, the two bearings supported by the fourth guide shaft and the second support shaft supported by the base body, so that the attitude of the Y stage with respect to the base body is defined.

In this case, the Y stage is also supported at three points like the X stage, so that the plane of the Y stage is also substantially parallel to the base body.

Here, it is preferable that the XY stage further includes:

a lid member that covers, from the Z direction, the X and Y stages and the stage to be moved,

wherein the base body includes:
two first support portions that fixedly support both ends of the first guide shaft, and each have the shape of a U groove opened toward the lid member;
two second support portions that fixedly support both ends of the fourth guide shaft, and each have the shape of a U groove opened toward the lid member;
a third support portion that supports the first support shaft so that the first support shaft freely slides in the X direction, and has the shape of a U groove opened toward the lid member; and
a fourth support portion that supports the second support shaft so that the second support shaft freely slides in the Y direction, and has the shape of a U groove opened toward the lid member, and

the lid member includes:
two first pressing portions that press the portions of the first guide shaft supported by the two first support portions, respectively;
two second pressing portions that press the portions of the fourth guide shaft supported by the two second support portions, respectively;
a first blocking piece that blocks an opening, which is opened toward the lid member, of the third support portion, and forms a first supporting hole into which the first support shaft is inserted, together with the third support portion; and
a second blocking piece that blocks an opening, which faces the lid member, of the fourth support portion, and forms a second supporting hole into which the second support shaft is inserted, together with the fourth support portion.

In this case, since the lid member is formed to serve as the pressing portions and the blocking pieces, there is no need to provide the pressing portions and blocking pieces of each guide shaft as separate members. Both ends of the first and fourth guide shafts can be elastically pressed by the first and second pressing portions of the lid member and be fixedly supported by the base body, and the first and second support shafts are supported in the first and second supporting holes, which are formed by the first and second blocking pieces, not to be restricted in the Z direction. For this reason, the smooth sliding of the stage to be moved is ensured.

In addition, it is also preferable that the XY stage further includes:

a first biasing member that is fixed to the lid member and biases the stage to be moved in the Z direction,

wherein the two bearings of the stage to be moved that are supported by the second guide shaft have rectangular through holes through which the second guide shaft passes having corners in the Z and Y directions, respectively.

In this case, the second guide shaft can be pressed at the portions of the rectangular through holes of the two bearings, which are biased by the first biasing member. Further, the second guide shaft can be supported at two positions, that is, adjacent sides of the through hole of each bearing. Therefore, the backlash of the stage to be moved in the Y direction is prevented.

It is also preferable that the XY stage further includes:

a first magnet that is fixed to the base body; and

a first coil board that includes a first coil, the first coil board being fixed to the X stage and generating a force for moving the X stage in the X direction by an interaction between itself and the first magnet when being supplied with current.

Here, it is also preferable that the XY stage further includes:

a second magnet that is fixed to the base body; and

a second coil board that includes a second coil, the second coil board being fixed to the Y stage and generating a force for moving the Y stage in the Y direction by an interaction between itself and the second magnet when being supplied with current.

That is, if the X and Y stage driving mechanisms are composed of the voice coil motors that include the first and second magnets and the first and second coil boards, respectively, it is possible to generate driving forces while the first and second magnets do not contact with the first and second coils fixed to the X and Y stages. Further, friction is not generated at the connection portion between the motor used as a driving source and each of the stages. For this reason, it is possible to further quickly move the X and Y stages as compared to a commonly-known motor.

The XY stage may further include a second biasing member that biases the stage to be moved against the X stage in the X direction.

In this case, the bearing supported by the third guide shaft is constantly biased in the X direction. Therefore, it is possible to prevent the stage to be moved from being shaken when the stage to be moved is reciprocated in the X direction.

Here, the XY stage may further include a lens fixed to the stage to be moved. Further, the XY stage may include an imaging device that is fixed to the stage to be moved, and outputs an image signal representing an object upon formation of an image of the object.

An image-taking apparatus of the present invention includes:

the XY stage according to claim 13;

an image-taking lens that forms an image of an object on the imaging device; and

a drive section that drives the XY stage so as to correct blurring of the image represented by an image signal output by the imaging device.

In this case, when shake occurs, for example, the XY stage is responsively driven by the voice coil motors used as the drive section of the XY stage, so that the shake is accurately corrected.

According to the present invention, it is possible to achieve an XY stage that is easily assembled with flatness and has low manufacturing cost, and an image-taking apparatus including the XY stage.

### BRIEF DESCRIPTION OF THE DRAWINGS

FIG. 1 is a view showing the appearance of an image-taking apparatus 1 including an XY stage according to an embodiment of the present invention;

FIG. 2 is a view showing the structure of an XY stage 110 according to an embodiment of the present invention;

FIG. 3 is an enlarged view of a flexible board shown in FIG. 2;

FIG. 4 is a view showing the structure of the XY stage 110 according to the embodiment of the present invention;

FIG. 5 is another view showing the structure of the XY stage 110 according to the embodiment of the present invention;

FIG. 6 is another view showing the structure of the XY stage 110 according to the embodiment of the present invention;

FIG. 7 is another view showing the structure of the XY stage 110 according to the embodiment of the present invention;

FIG. 8 is another view showing the structure of the XY stage 110 according to the embodiment of the present invention;

FIG. 9 is another view showing the structure of the XY stage 110 according to the embodiment of the present invention;

FIG. 10 is another view showing the structure of the XY stage 110 according to the embodiment of the present invention;

FIG. 11 is a view showing the arrangement of magnets MG1 and MG2, and the positional relationship among bonded bodies YM1 and YM2, hall elements h1 and h2, opposite yokes Y12 and Y22, and additional yokes Y13 and Y23; and

FIG. 12 is a view illustrating the output of a hall element during adjustment.

### DETAILED DESCRIPTION OF THE INVENTION

An embodiment of the present invention will be described below with reference to the accomapnying drawings.

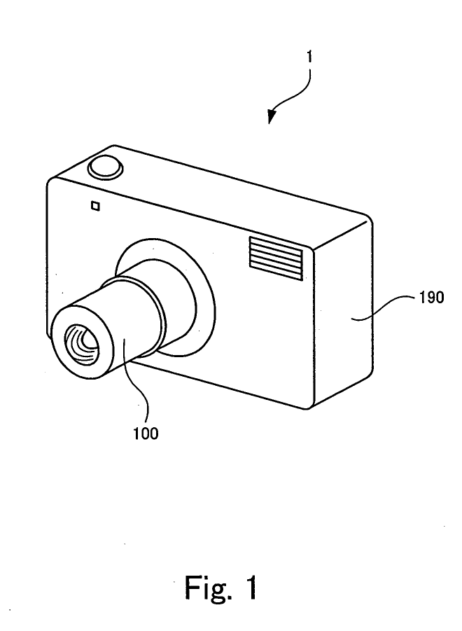

FIG. 1 is a view showing the appearance of an image-taking apparatus 1 including an XY stage according to an embodiment of the present invention.

An image-taking apparatus 1 of FIG. 1 includes an XY stage according to an embodiment of the present invention. This embodiment illustrates an example in which an imaging device is held by the XY stage. The XY stage is driven according to camera shake at the time of taking an image, so that the imaging device is moved to correct the shake.

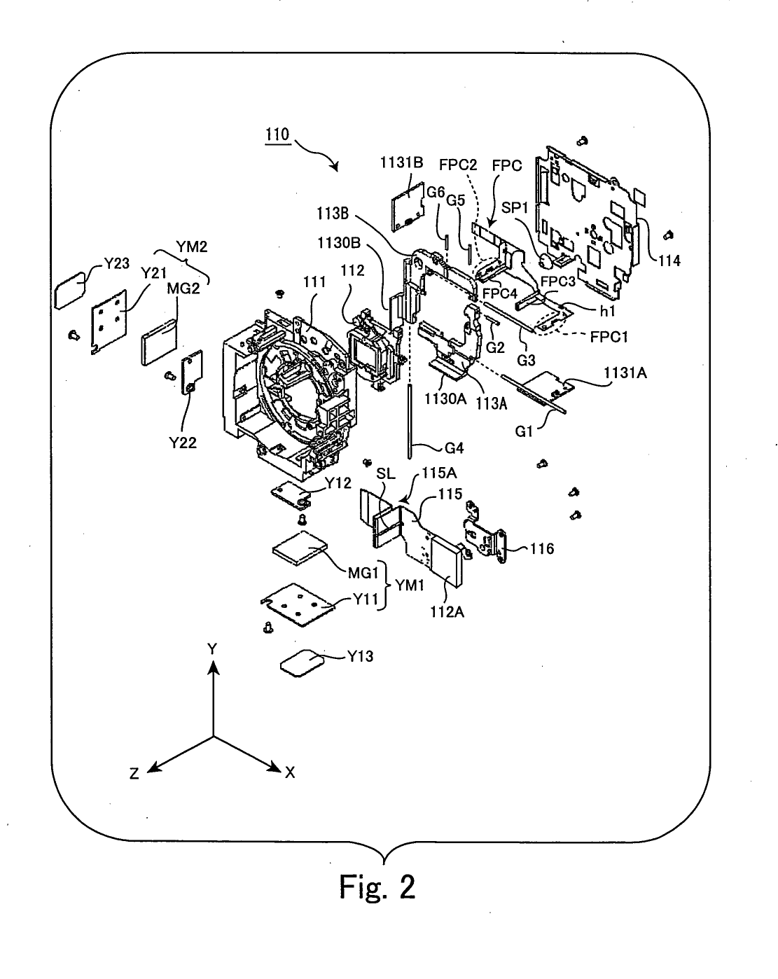

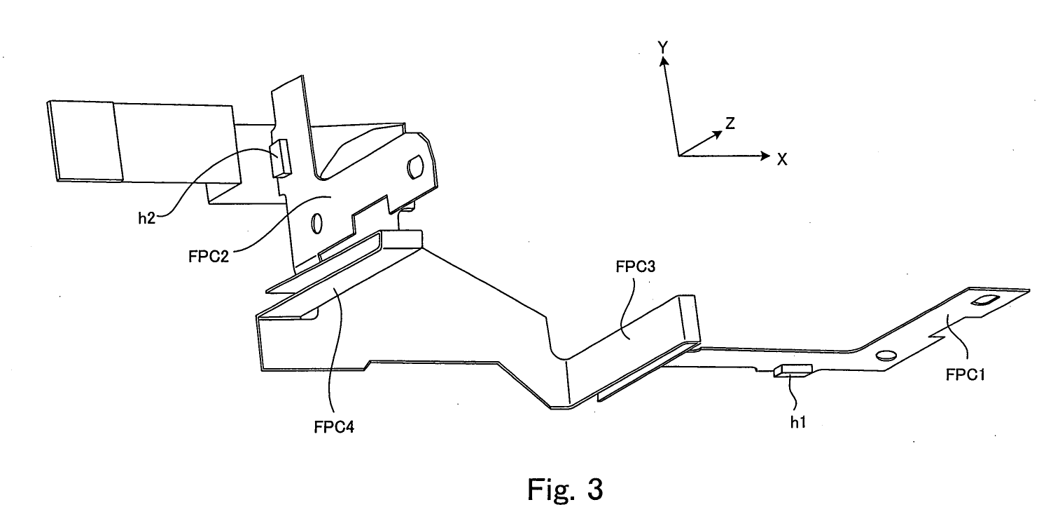

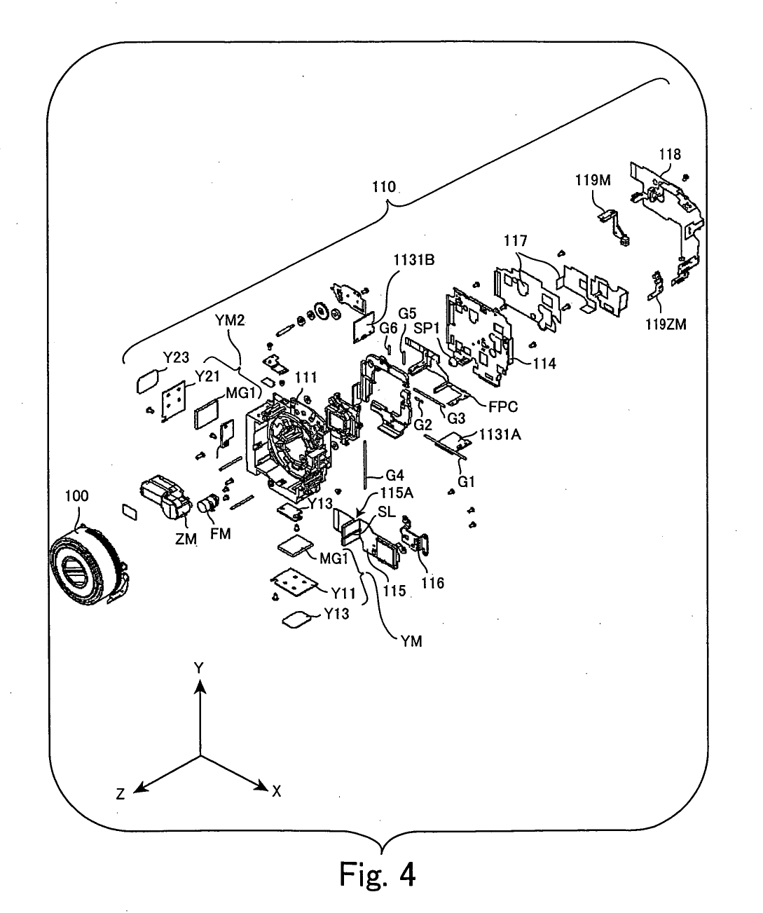

In the image-taking apparatus of FIG. 1, the XY stage for holding the imaging device is provided near a connection portion between a lens barrel 100 and a camera body 190. FIGS. 2 to 10 are views showing the structure of the XY stage 110 according to the embodiment of the present invention. An X axis, a Y axis, and a Z axis are shown in FIGS. 2 to 4 in order to clarify X and Y directions of the XY stage 110. The directions of three axes of FIG. 2 are the same as those of FIG. 4. However, since FIG. 3 shows a view seen in a different direction for the purpose of easily understanding the structure of a flexible board FPC, the directions of three axes shown in FIG. 3 are different from those of FIGS. 2 and 4. In the following description, directions are indicated with these axes.

FIG. 2 is an exploded view of the XY stage 110, and FIG. 3 is an enlarged view of the flexible board FPC of FIG. 2. FIG. 4 shows an exploded view of FIG. 2 and shows the lens barrel 100 to which the XY stage 110 is mounted. Further, a zoom motor ZM, a focus motor FM, parts used to mount the motors to the lens barrel 100, a main FPC 118 used to be connected to a control section provided in the image-taking apparatus 1 of FIG. 1, an anti-dust tape 117, and the like are also shown in FIG. 4. Furthermore, since a CCD solid state imaging device 112A is used as the imaging device in this embodiment, the imaging device is referred to as a CCD 112A in the following description.

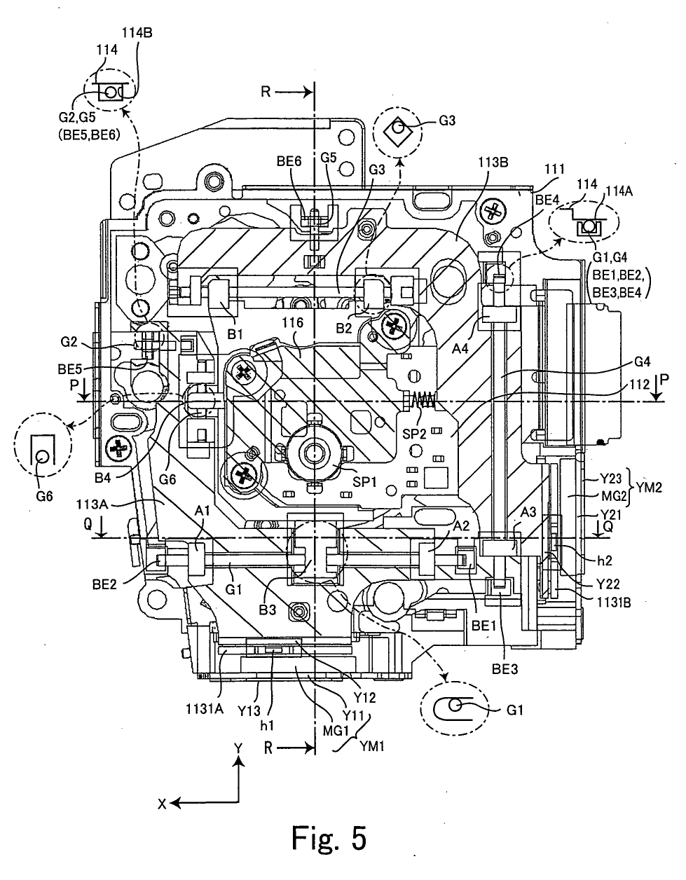

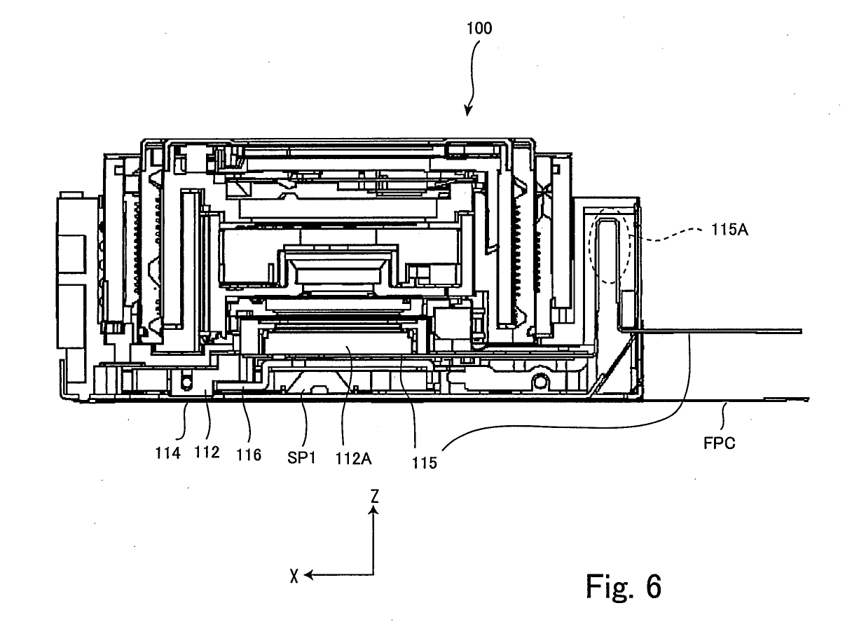

In addition, FIG. 5 is a view showing a state where the XY stage 110 is assembled and mounted to the lens barrel 100, under the assumption that a lid member 114 is transparent, as seen from the lid member 114 in a Z direction. FIGS. 6 to 10 are an X cross-sectional view showing a cross section taken along a line that is represented by reference character P of FIG. 5, an X cross-sectional view showing a cross section taken along a line that is represented by reference character Q of FIG. 5, a right side view, a Y cross-sectional view showing across section taken along a line that is represented by reference character R of FIG. 5, and a bottom view of FIG. 5, respectively.

First, each member of the XY stage 110 will be described with reference to FIG. 2.

As shown in FIG. 2, the XY stage 110 may include many members in addition to a base body 111. Members, such as a CCD holder 112, an X stage 113A, and a Y stage 113B, among the many members are mounted on the base body 111, so that the XY stage is assembled. When the assembled XY stage 110 is mounted to the lens barrel 100 shown in FIG. 4, the structure shown in FIGS. 5 to 10 is formed.

First, the structure of the XY stage 110 will be described with reference to FIG. 2.

The CCD holder 112, which is a stage to be moved, is shown at the center of FIG. 2. A flexible board 115 shown on the lower side is connected to the CCD 112A, which is provided in the CCD holder 112, by soldering. The flexible board 115 is fixed to the CCD holder 112 so as to be pressed against the CCD 112A by a CCD plate 116. Meanwhile, the flexible board 115 has holes for adhesion, an adhesive flows into the holes, and the CCD plate 116 is fixed to the CCD 112A by adhesion with the flexible board 115 interposed therebetween. Further, a bending portion 115A is formed at the flexible board 115 protruding from the CCD 112A, and a slit SL is formed at the bending portion 115A. For this reason, after the flexible board 115 is mounted, X-directional stress applied to the middle of the flexible board 115 on which the CCD 112A slides is absorbed by the bending portion 115A and Y-directional stress applied to the flexible board 115 when the CCD 112A slides is absorbed by the slit SL.

That is, in this embodiment, as each of the X and Y stages 113A and 113B slides, all of the CCD 112A, the CCD holder 112 for holding the CCD 112A, the flexible board 115 connected to the CCD 112A by soldering, and the CCD plate 116 slide.

Meanwhile, the X and Y stages 113A and 113B are shown at the center of FIG. 2. The X and Y stages move the CCD holder 112, which is the stage to be moved, and the like in the X and Y directions, respectively. The X stage 113A of FIG. 2 surrounds one half of the periphery of a central axis, is supported by the base body 111 so as to freely slide in the X direction, and supports the CCD holder 112 so that the CCD holder is restricted in the X direction and freely slides in the Y direction. Accordingly, the X stage moves the CCD holder 112 in the X direction by sliding in the X direction. The Y stage 113B of FIG. 2 surrounds the other half of the periphery of the central axis, is supported by the base body 111 so as to freely slide in the Y direction, and supports the CCD holder 112 so that the CCD holder is restricted in the Y direction and freely slides in the X direction. Accordingly, the Y stage moves the CCD holder 112 in the Y direction by sliding in the Y direction. A state where the stages 113A and 113B are mounted on the base body 111 will be described in detail below with reference to FIG. 5. Meanwhile, voice coil motors disclosed in the conventional technique are used to slide the X and Y stages 113A and 113B.

As widely known, the voice coil motor includes a magnet, a coil, and a yoke. In this embodiment, the X and Y stages 113A and 113B are provided with a first board fixing part 1130A and a second board fixing part 1130B, respectively. First and second coil boards 1131A and 1131B, which serve as movable elements of the voice coil motor, are fixed to the board fixing parts 1130A and 1130B, respectively. In addition, magnets MG1 and MG2, yokes Y11 to Y13 and Y21 to Y23, the X stage 113A, and the Y stage 113B, which are used to drive the coil boards 1131A and 1131B, are mounted on the base body 111, so that the voice coil motor is assembled. That is, in this embodiment, each of an X stage driving mechanism and a Y stage driving mechanism is composed of a voice coil motor.

The magnets MG1 and MG2 and three kinds of the yokes Y11 to Y13 and Y21 to Y23, which form the X and Y stage driving mechanisms, are shown at the left side of FIG. 2 so as to correspond to the coil boards 1131A and 1131B of the X and Y stages 113A and 113B outside outer walls of the base body 111. Meanwhile, three kinds of the yokes Y11 to Y13 and Y21 to Y23 are provided to correspond to the first and second coil boards 1131A and 1131B, which are provided in the X and Y stages 113A and 113B, respectively. Accordingly, in the following description, the yoke of the X stage driving mechanism corresponding to reference numeral Y11 is referred to as a first yoke, the yoke of the Y stage driving mechanism corresponding to reference numeral Y21 is referred to as a second yoke, the yoke of the X stage driving mechanism corresponding to reference numeral Y12 is referred to as a third yoke (hereinafter, referred to, in some cases, as an opposite yoke because the yoke is provided to face the first magnet), the yoke of the Y stage driving mechanism corresponding to reference numeral Y22 is referred to as a fourth yoke (hereinafter, referred to, in some cases, as an opposite yoke because the yoke is provided to face the second magnet), the yoke of the X stage driving mechanism corresponding to reference numeral Y13 is referred to as a first sub-yoke, and the yoke of the Y stage driving mechanism corresponding to reference numeral Y23 is referred to as a second sub-yoke. Further, since the first yoke Y11 is fixed to the first magnet MG1 by adhesion and the second yoke Y21 is fixed to the second magnet MG2 by adhesion, the first yoke and the first magnet are referred to as a first bonded body YM1 and the second yoke and the second magnet are referred to as a second bonded body YM2.

That is, in this embodiment, the X stage driving mechanism includes the first bonded body YM1 and the first coil board 1131A. The first bonded body YM1 includes the first magnet MG1 that extends on an X-Z plane and faces the X stage 113A, and the first yoke Y11 that is fixed to the backside of the first magnet MG1 as seen from the X stage 113A. The first coil board 1131A includes a first coil. The first coil is fixed to the X stage 113A at a position facing the first magnet MG1, and generates a force for driving the X stage 113A in the X direction by an interaction between itself and the first magnet MG1 when being supplied with current. The Y stage driving mechanism includes the second bonded body YM2 and the second coil board 1131B. The second bonded body YM2 includes the second magnet MG2 that extends on a Y-Z plane and faces the Y stage, and the second yoke Y21 that is fixed to the backside of the second magnet MG2 as seen from the Y stage 113B. The second coil board 1131B includes a second coil. The second coil is fixed to the Y stage 113B at a position facing the second magnet MG2, and generates a force for driving the Y stage 113B in the Y direction by an interaction between itself and the second magnet MG2 when being supplied with current.

The first yoke Y11 is a member that has a width larger than the first magnet MG1 in the X direction. The X stage driving mechanism includes the first sub-yoke Y13. The first sub-yoke is fixed to the backside of the first yoke Y11 as seen from the first magnet MG1 at a position facing the first magnet MG1, and has a width smaller than the first yoke Y11 in the X direction. The second yoke Y21 is a member that has a width larger than the second magnet MG2 in the X direction. The Y stage driving mechanism includes the second sub-yoke Y23. The second sub-yoke is fixed to the backside of the second yoke Y21 as seen from the second magnet MG2 at a position facing the second magnet MG2, and has a width smaller than the second yoke Y21 in the X direction.

Although not shown in FIG. 2, recesses receiving the magnets MG1 and MG2 and three kinds of the yokes Y11 to Y13 and Y21 to Y23 are formed on the outer walls of the base body 111 where the X and Y stage driving mechanisms of FIG. 2 are provided, so as to correspond to the X and Y stages 113A and 113B. First, the opposite yokes Y12 and Y22 are provided in the recesses, and then screwed on the inner walls of the recesses, respectively. Then, the first and second bonded bodies YM1 and YM2, which include the magnets MG1 and MG2 and the first yokes Y11 and Y22, are screwed on the outer walls of the base body 111, respectively. Further, the first and second sub-yokes Y13 and Y23, which have lengths smaller than the first and second yokes in the X and Y directions, are fixed to the bask sides of the first and second yokes Y11 and Y22 of the bonded bodies as seen from the magnets at positions facing the magnets, respectively. The coil boards 1131A and 1131B, which are fixed to the board fixing parts 1130A and 1130B of the X and Y stages 113A and 113B, are provided in gaps, which are formed between the first and second bonded bodies YM1 and YM2 and the opposite yokes Y13 and Y23 placed at the positions facing the surfaces of these bonded bodies, around the outer walls of the base body 111, so that the X and Y stages 113A and 113B are mounted on the base body 111.

Therefore, when current flows through the coil boards 1131A and 1131B, the coil boards 1131A and 1131B slide parallel to the magnets MG1 and MG2 (in the X and Y directions) by Fleming's left-hand rule. As a result, the CCD holder 112, which is a stage to be moved and the CCD 112A held by the CCD holder 112, are moved according to the movement of the coil boards 1131A and 1131B fixed to the board fixing parts 1130A and 1130B of the stages 113A and 113B.

In this way, the X stage 113A, the Y stage 113B, and the CCD holder 112 are mounted on the base body 111 so as to be quickly moved according to the current flowing through the coils of the coil boards 1131A and 1131B.

Subsequently, how guide shafts G1, G3, G4, and G6 and support shafts G2 and G5 are mounted on the base body 111 will be briefly described. The guide shafts G1, G3, G4, and G6 are inserted into or fixed to the X and Y stages 113A and 113B.

First, how the two guide shafts G1 and G3 and the single support shaft G2 extending in the X direction are arranged and mounted on the base body 111 will be briefly described with reference to FIG. 2.

First, the X stage 113A is provided with two bearings (to be described later). The first guide shaft G1, which extends in the X direction and is fixedly supported by the base body 111, is inserted into the two bearings, and both ends of the first guide shaft G1 are fitted to the bearings provided in the base body 111 and are fixedly supported by the base body 111. In addition, one end of the first support shaft G2, which protrudes in the X direction and is supported by the base body 111 so as to freely slide in the X direction, is fixedly supported by the X stage 113A. Both ends of the first guide shaft G1 are fitted to the bearings, which have the shape of a U groove, of the base body 111, respectively, and are pressed by pressing portions (to be described later) of a lid member. Accordingly, both ends of the first guide shaft is fixedly supported by the base body 111.

In addition, both ends of the second guide shaft G3 extending in the X direction are fixedly supposed by the Y stage 113B, and two bearings (to be described later) provided in the CCD holder 112 are connected to the second guide shaft G3 in a manner slidable in the X direction, so that the CCD holder 112 is connected to the Y stage 113B. As described above, the second guide shaft G3 restricts the CCD holder 112, which is a stage to be moved, in the Y direction, and helps the CCD holder 112 to be moved only in the X direction.

Meanwhile, both ends of the third guide shaft G6 of three shafts extending in the Y direction are fixed to the X stage 113A, and another bearing (to be described later) provided in the CCD holder 112 is connected to the third guide shaft G6 so as to freely slide in the Y direction, so that the CCD holder 112 is connected to the X stage 113A. The third guide shaft G6 extending in the Y direction is fixedly supported by the X stage 113A, so that the third guide shaft G6 restricts the CCD holder 112 in the X direction and helps the CCD holder to be moved only in the Y direction.

Further, the fourth guide shaft G4 is inserted into two bearings provided in the Y stage 113B. Both ends of the fourth guide shaft G4 are fitted to the bearings, which have the shape of a U groove, of the base body 111, respectively, and are pressed by pressing portions (to be described later) of the lid member 114. Accordingly, both ends of the fourth guide shaft G4 are fixedly supported by the base body 111. Furthermore, the second support shaft G5 is fixed to the Y stage 113B.

In this way, the stages 113A and 113B, the guide shafts G1 and G4, and the support shafts G2 and G5 are mounted on the base body 111. These guide shafts and support shafts make the CCD holder 112, which is a stage to be moved, freely slide. Further, the guide shafts G3 and G6, which restrict the movement of the CCD holder 112 in one direction, are fixedly supported by the Y stage 113B and the X stage 113A, respectively. Accordingly, each of the stages 113A and 113B and the CCD holder 112 is mounted on the base body 111. A state where these stages and CCD holder are mounted on the base body will be described in detail below with reference to FIG. 5.

Further, wiring should be performed on the coil boards 1131A and 1131B provided in the stages so that current flows through coils on the coil boards. Accordingly, a flexible board FPC for this purpose is shown in FIG. 2. As shown in FIG. 3, the flexible board FPC includes: a first fixing part FPC1 fixed to the first coil board 1131A to form a channel of current supplied to the first coil; and a second fixing part FPC2 fixed to the second coil board 1131B to form a channel of current supplied to the second coil. In this embodiment, a single flexible board FPC is connected to two coil boards 1131A and 1131B, but two flexible boards may be separately provided.

The flexible board FPC shown in FIG. 3 includes a first bending portion FPC3 of which surfaces face each other in the X direction when being bent in the Z direction, and a second bending portion FPC4 of which surfaces face each other in the Y direction when being bent in the Z direction. Meanwhile, first and second hall elements h1 and h2, which detect X and Y directional positions of the X and Y stages by detecting magnetic forces of the first and second magnets MG1 and MG2, are mounted on portions of the flexible board FPC that are fixed to the first and second coil boards 1131A and 1131B. Accordingly, transmission paths along which detection signals obtained by the hall elements h1 and h2 are transmitted are also formed on this flexible board.

While the X stage 113A is moved in the X direction, stress applied to the flexible board FPC is absorbed by the first bending portion FPC3. While the Y stage is moved in the Y direction, Y-directional stress applied to the flexible board FPC is absorbed by the second bending portion FPC4.

When the wiring using the flexible board FPC is completed, the lid member 114 covers the X stage 113A, the Y stage 113B, and the CCD holder 112 in the Z direction at the last, thereby completing the assembling.

A state where the stages 113A and 113B are mounted on the base body 111 so that the XY stage 110 is assembled, and the XY stage 110 is mounted to the lens barrel 100 will be described below with reference to FIG. 5.

As described above, FIG. 5 is a view showing a state where the XY stage 110 is mounted to the lens barrel 100, under the assumption that the lid member 114 is transparent, as seen from an upper right side of FIGS. 2 and 4, that is, in the Z direction.

As described with reference to FIG. 2, the first to fourth guide shafts and the first and second support shafts G1 to G6 are mounted to the stages 113A and 113B and the base body 111, so that each of the stages is supported by the base body 111. Therefore, the structure around the shafts including the guide shafts and the support shafts will be described first.

As shown in FIG. 5, the X and Y stages 113A and 113B are provided with two sets of bearings A1, A2 and A3, A4 into which the first and fourth guide shafts G1 and G4 are inserted, respectively.

Further, the base body 111 shown in FIG. 5 includes two first support portions BE1 and BE2, two second support portions BE3 and BE4, a third support portion BE5, and a fourth support portion BE6. The first support portions BE1 and BE2 fixedly support both ends of the first guide shaft G1, and each have the shape of a U groove opened toward the lid member 114. The second support portions BE3 and BE4 fixedly support both ends of the fourth guide shaft G4, and each have the shape of a U groove opened toward the lid member 114. The third support portion BE5 supports the first support shaft G2 so that the first support shaft G2 freely slides in the X direction, and has the shape of a U groove opened toward the lid member 114. The fourth support portion BE6 supports the second support shaft G5 so that the second support shaft G5 freely slides in the Y direction, and has the shape of a U groove opened toward the lid member 114. Since the first support portions BE1 and BE2 and the second support portions BE3 and BE4 have the same structure, FIG. 5 shows an enlarged view of the structure of one support portion BE4 of the second support portions BE3 and BE4. Further, since the third support portion BE5 and the fourth support portion BE6 have the same structure, FIG. 5 shows an enlarged view of the structure of the support portion BE5. Furthermore, FIG. 5 also shows an enlarged view of the structure of two bearings B1 and B2 of the CCD holder 112 that are supported by the second guide shaft G3, and an enlarged view of the structure of one bearing B3 of the CCD holder 112 that is supported by the first guide shaft G1.

That is, the first guide shaft G1 is inserted into two bearings A1 and A2 of the X stage 113A, and both ends of the first guide shaft G1 are fitted to the first support portions BE1 and BE2, so that the first guide shaft G1 and the X stage 113A are supported by the base body 111. The fourth guide shaft G4 is inserted into the bearings A3 and A4 of the Y stage 113B, and both ends of the fourth guide shaft G4 are fitted to the second support portions BE3 and BE4, so that the fourth guide shaft G4 and the Y stage 113B are supported by the base body 111.

In this embodiment, in order to make the lid member 114 be covered from the frontside of the plane of FIG. 5 at the last, the lid member 114 includes two first pressing portions 114A, two second pressing portions 114A, a first blocking piece, and a second blocking piece. The first pressing portions 114A press the portions of the first guide shaft G1 that are supported by the two first support portions BE1 and BE2, respectively. The second pressing portions 114A press the portions of the fourth guide shaft G4 that are supported by the two second support portions BE3 and BE4, respectively. The first blocking piece blocks an opening, which faces the lid member 114, of the third support portion BE5, and forms a first supporting hole 114B into which the first support shaft G2 is inserted, together with the third support portion BE5. The second blocking piece blocks an opening, which faces the lid member 114, of the fourth support portion BE6, and forms a second supporting hole 114B into which the second support shaft G5 is inserted, together with the fourth support portion BE6. Therefore, the X and Y stages 113A and 113B are preferably supported by the bearings that are provided in the lid member 114 and the base body 111.

In addition, the lid member 114 is provided with a spring member SP1 serving as a biasing member that is fixed to the lid member 114 and biases the CCD holder 112 in the Z direction. Rectangular through holes through which the second guide shaft G3 passes are formed at the two bearings B1 and B2, respectively, of the CCD holder 112 that are supported by the second guide shaft G3. The rectangular through hole has corners in the Z and Y directions as shown in the enlarged view of FIG. 5. Accordingly, the second guide shaft G3 which is a rounded guide bar is pressed and supported at the two points on two of the four sides forming the rectangular through hole, so that a backlash in the Y direction is absorbed and friction is decreased.

Further, the lid member 114 is also provided with a spring SP2 serving as a biasing member that makes the CCD holder 112 be biased in the X direction with respect to the X stage and thus the CCD holder 112 is biased in the X direction by the spring SP2. Accordingly, the X stage is constantly biased in one direction. As a result, when the CCD holder 112, which is the stage to be moved, is moved, a backlash in the X direction is absorbed.

In this way, the CCD holder 112 is appropriately supported by the spring SP1 and the bearings, which connect the X and Y stages 113A and 113B with the base body 111 and connect the X and Y stages 113A and 113B with the CCD holder 112, so that the backlash of the CCD holder 112 is suppressed during the sliding of the CCD holder 112.

Further, although having been described with reference to FIG. 2, the structure of the X and Y stage driving mechanisms will be described again with reference to FIG. 5 in order to further clarify the assembled structure.

As described above, the X stage driving mechanism shown in FIG. 5 includes the first bonded body YM1 and the first coil board 1131A. The first bonded body YM1 includes the first magnet MG1 that extends on the X-Z plane and faces-the X stage, and the first yoke Y11 that is fixed to the backside of the first magnet MG1 as seen from the X stage 113A. The first coil board 1131A includes the first coil. The first coil is fixed to the X stage 113A at a position facing the first magnet MG1, and generates a force for driving the X stage 113A in the X direction by an interaction between itself and the first magnet MG1 by being supplied with current. Further, the Y stage driving mechanism includes the second bonded body YM2 and the second coil board 1131B. The second bonded body YM2 includes the second magnet MG2 that extends on the Y-Z plane and faces the Y stage, and the second yoke Y21 that is fixed to the backside of the second magnet MG2 as seen from the Y stage 113B. The second coil board 1131B includes the second coil. The second coil is fixed to the Y stage 113B at a position facing the second magnet MG2, and generates a force for driving the Y stage 113B in the Y direction by an interaction between itself and the second magnet MG2 by being supplied with current.

The first yoke Y11 is a member that has a width larger than the first magnet MG1 in the X direction. The X stage driving mechanism includes the first sub-yoke Y13. The first sub-yoke Y13 is fixed to the backside of the first yoke Y11 as seen from the first magnet MG1 at a position facing the first magnet MG1, and has a width smaller than the first yoke Y11 in the X direction. The second yoke Y21 is a member that has a width larger than the second magnet MG2 in the X direction. The Y stage driving mechanism includes the second sub-yoke Y23. The second sub-yoke Y23 is fixed to the backside of the second yoke Y21 as seen from the second magnet MG2 at a position facing the second magnet MG2, and has a width smaller than the second yoke Y21 in the X direction.

In this way, the first and second coil boards 1131A and 1131B, which are fixed to the first and second board fixing parts 1130A and 1130B, respectively, are efficiently provided among the first magnet MG1, the second yoke Y12 facing the first magnet MG1, the second magnet MG2, and the fourth yoke Y22 facing the second magnet MG2. The stages and the voice coil motor for driving each of the stages are mounted to the base body.

In this embodiment, the first and third yokes Y11 and Y12 are provided to face each other with the magnet MG1 interposed therebetween, and the second and fourth yokes Y21 and Y22 are provided to face each other with the magnet MG2 interposed therebetween. In addition, the first and second sub-yokes Y13 and Y23 are provided on the backsides of the first and second yokes Y11 and Y21 so as to face the magnets MG1 and MG2, respectively, so that it is possible to suppress leakage of magnetic flux to the minimum extent. Therefore, it is possible to efficiently apply a magnetic force to the coil board 1130A.

In this way, the guide shafts, the support shafts, and the X and Y driving mechanisms are mounted to the base body, so that the XY stage is assembled.

Hereinafter, the structure of the XY stage 110 after it is mounted to the lens barrel 100 will be briefly described with reference to FIGS. 6 to 10.

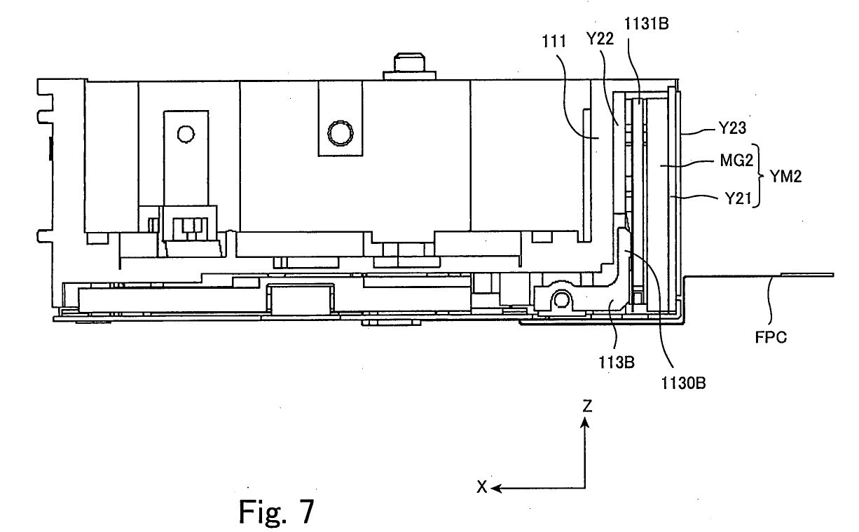

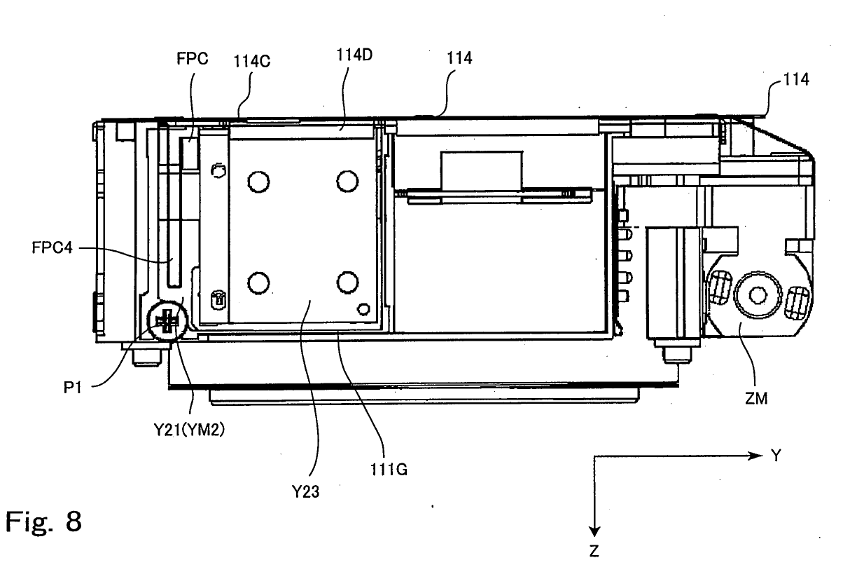

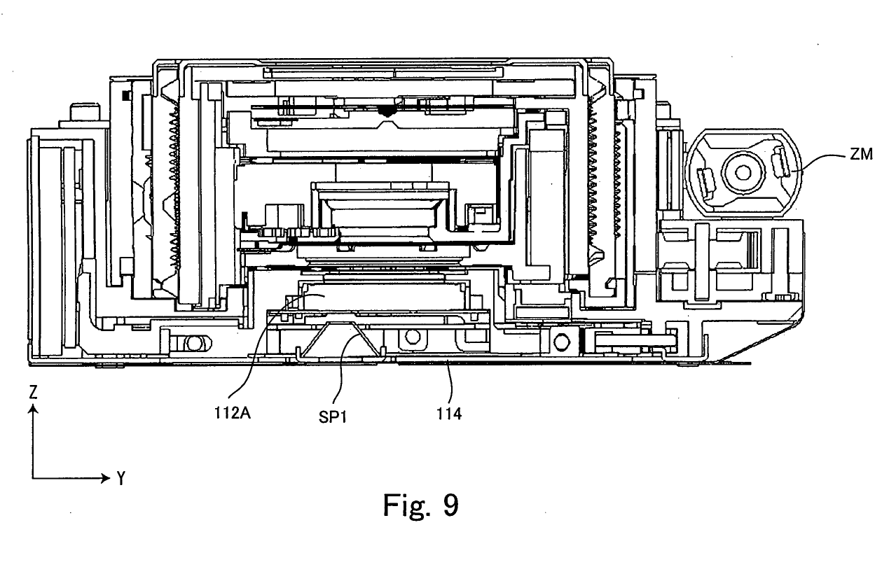

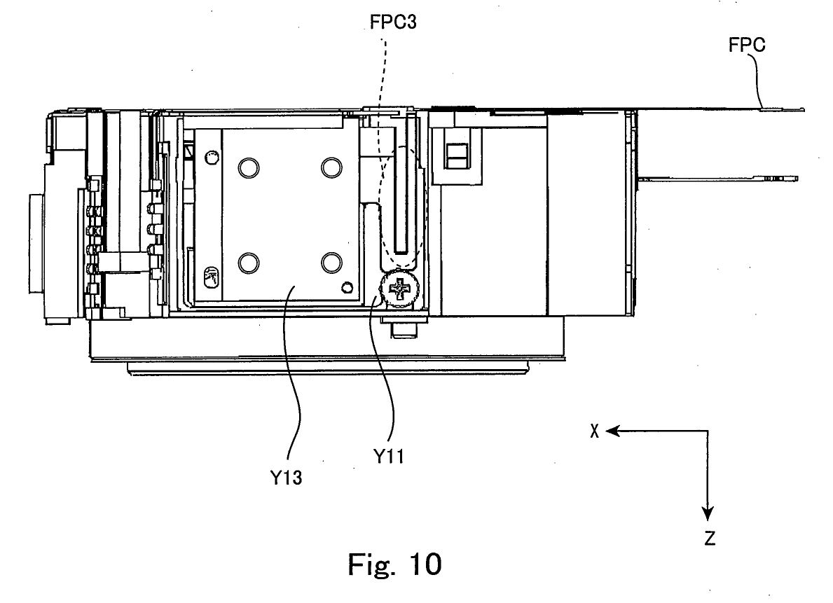

FIG. 6 is an X cross-sectional view showing a cross section taken along a line that is represented by reference character P of FIG. 5, FIG. 7 is an X cross-sectional view showing a cross section taken along a line that is represented by reference character Q of FIG. 5, FIG. 8 is a right side view of FIG. 5, FIG. 9 is a Y cross-sectional view showing a cross section taken along a line that is represented by reference character R of FIG. 5, and FIG. 10 is a bottom view of FIG. 5.

The positional relationship among the components of the XY stage 110 will be briefly described with reference to FIGS. 6 to 10.

As shown in FIGS. 6 and 9, the XY stage 110 is mounted on the rear side of the lens barrel 100, and each of the components of the XY stage 110 is mounted to the lens barrel 100 so that the CCD plate 116 and the CCD holder 112 are biased toward the lens barrel 100 by the spring SP1 that is provided on the lid member 114 to be covered at the last.

As shown in FIG. 6, a CCD 110A is mounted on the CCD holder 112, and the flexible board 115 is connected to the CCD 110A. If the flexible board 115 is drawn to the outside while being stripped, there is a concern that the flexible board 115 is scratched while the CCD 110A and the CCD holder 112 are moved. For this reason, the CCD plate 116 is pressed against the CCD holder 112 by the spring SP1 of the lid member 114 so that the flexible board 115 is interposed between the CCD plate 116 and the CCD holder 112, thereby correcting the attitude of the flexible board.

In addition, as previously described with reference to FIG. 2, the U-shaped bending portion 115A is formed at the flexible board 115 in the X direction, and is mounted in an empty space that is formed by the lid member 114 and the base body 111. As described above, the slit is formed at the bending portion in the Y direction. Accordingly, even though X and Y-directional stress is applied to the flexible board 115 while the CCD holder 112 slides, the stress is reduced by the bending portion 115A and the slit SL (see FIG. 2). Further, there is no need to increase the size of the base body for the purpose of securing a wiring space and therefore it is possible to achieve miniaturization of the XY stage.

Further, as previously described with reference to FIG. 2, FIG. 7 shows a state where the opposite yoke (fourth yoke) Y22 is screwed on the inner wall of the recess formed on the outer wall of the base body 111 and the second bonded body YM2 obtained by bonding the second yoke Y21 to the magnet MG2 is fixed to the outer wall of the base body 111.

The Y stage 113B is provided with the second board fixing part 1130B of which dimension in the Z direction is smaller than that of the base body 111 in the Z direction. The second coil board 1131B, which extends in the Z and Y directions outside and around the outer walls of the base body 111, is fixed to the second board fixing part 1130B.

Further, the Y stage driving mechanism is provided with the fourth yoke Y22 that is disposed between the outer wall of the base body 111 and the second coil board 1131B not to interfere with the second board fixing part 1130B in the Z direction.

The coil board 1131B is provided in a gap between the magnet MG2 and the opposite yoke (fourth yoke) Y22, around the outer wall of the base body 111. Meanwhile, the bonded body YM2 is obtained by bonding the second yoke Y21 to the backside of the magnet MG2, and then mounted to the base body.

Although not shown in drawings, the structure of the X stage 113A is also the same as that shown in FIG. 7.

When the Y stage 113B connected to the coil board 1131B of FIG. 7 and the coil board 1131B are moved from front to back or from back to front in a direction perpendicular to the plane of the drawing, the Y stage 113B also slides in the Y direction.

According to this embodiment, the voice coil motor of the X stage driving mechanism and the voice coil motor of the Y stage driving mechanism are closely mounted in a very small space as described above, and smaller driving mechanisms as compared to the conventional technique are mounted to the XY stage, so that the miniaturization of the XY stage is achieved.

The structure for simply adjusting the outputs of the hall elements h1 and h2 (linearity is obtained) is employed in this embodiment in order to accurately detect the position of each of the coil boards 1131A and 1131B by the hall elements h1 and h2 mounted on the flexible board FPC. Accordingly, this structure will be described.

FIG. 8 is a right side view of FIG. 5. Since the Y stage driving mechanism for driving the Y stage 113B is provided on the right side in FIG. 5, FIG. 8 shows the first yoke Y21 provided in the Y stage driving mechanism and the additional yoke Y23 bonded to the backside of the first yoke. As described above, the first yoke Y21 is fixed to the magnet MG2 by adhesion. The structures of the X stage driving mechanism and the Y stage driving mechanism are the same and thus, only the structure of the Y stage driving mechanism of FIG. 8 will be described.

FIG. 8 shows that the second bending portion FPC4 of the flexible board FPC is mounted in a small space formed by the base body 111 and the lens barrel 100.

As described above, the Y stage driving mechanism, which moves the coil board to which current flows through the flexible board FPC in a magnetic field, is mounted on the base body 111, and the second yoke Y21 and the second sub-yoke Y23 provided in the Y stage driving mechanism are shown in FIG. 8. As described above, the magnet MG2 (see FIG. 5) is fixed to the second yoke Y21 by adhesion, so that the second bonded body YM2 is formed.

The base body 111 shown in FIG. 8 is provided with a guide part 111G. This guide part comes in contact with one side of the second bonded body YM2 extending in the Y direction, and is used as a guide when the position of the second bonded body YM2 is adjusted in the Y direction. In addition, the lid member 114 is provided with a guide piece 114C. The second bonded body YM2 is interposed between the guide part 111G of the base body 111 and the guide piece 114C, and the guide piece 114C serves as a guide together with the guide part 111G when the position of the second bonded body YM2 is adjusted in the Y direction. The lid member 114 is further provided with a first backside guide part 114D that comes in contact with the backside of the second bonded body YM2 as seen from the Y stage so as to guide the backside of the second bonded body YM2.

Hereinafter, although the drawing number is out of sequence, the structure of portions for adjusting sensitivity will be described.

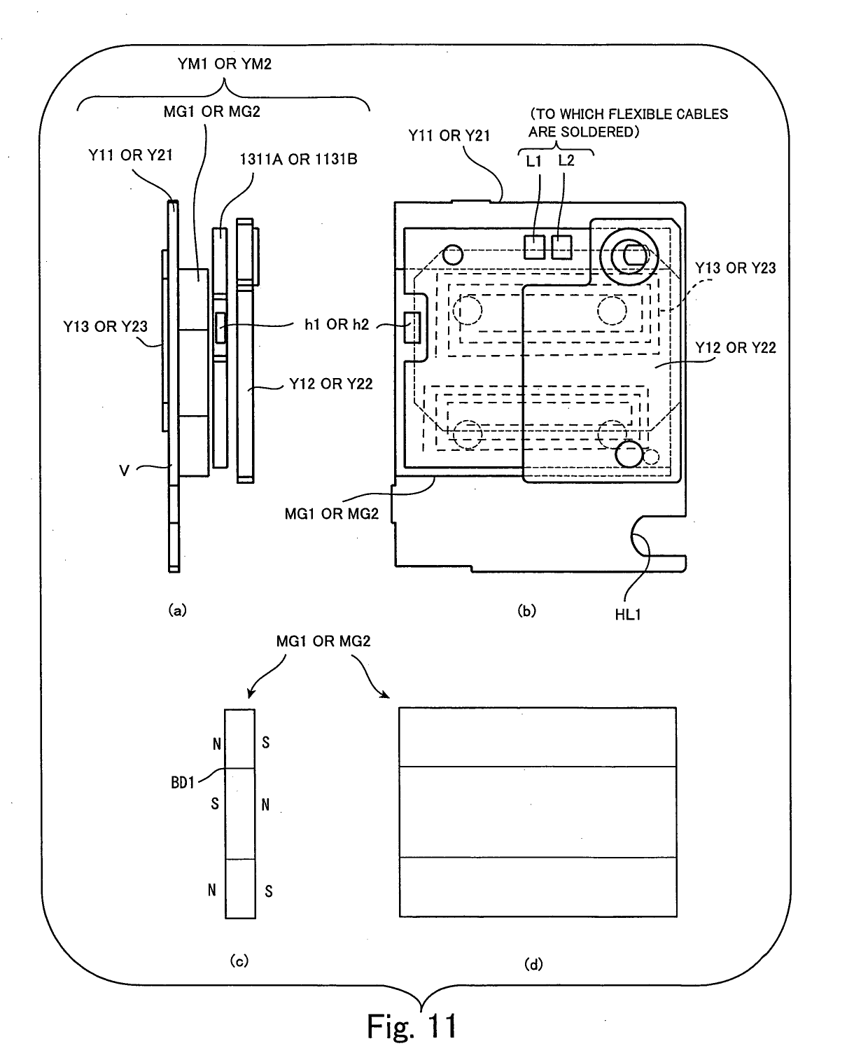

FIG. 11 is a view showing the structure of the magnets MG1 and MG2, and the positional relationship among the bonded bodies YM1 and YM2, the hall elements h1 and h2, the first, third, second, and fourth yokes Y11, Y12, Y21, and Y22, and the first and second sub-yokes Y13 and Y23.

Part (a) of FIG. 11 shows the positional relationship among the coil boards 1131A and 1131B and the yokes Y11 to Y13 and Y21 to Y23, that have been described with reference to FIG. 7, and the positions of the hall elements h1 and h2. Part (b) of FIG. 11 shows the positional relationship among the first yoke Y11 or the second yoke Y21, the third yoke Y12 or the fourth yoke Y22, and the first coil board 1131A or the second coil board 1131B. Further, Parts (c) and (d) of FIG. 11 show the arrangement of the magnet MG1 or MG2.

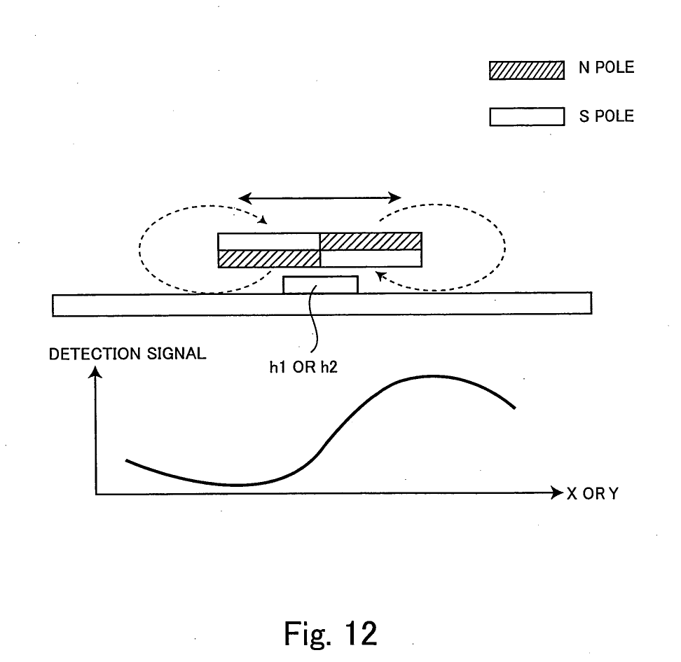

Furthermore, FIG. 12 is a view illustrating the change in the output of the hall element h1 or h2 while the bonded body is moved along the guide 111G shown in FIG. 8 (in a direction indicated by an arrow of the drawing).

A narrow hole HL1, which forms a fastening portion communicating with a threaded hole of the base body, is formed at the first bonded body YM1 or the second bonded body YM2. The positional adjustment of the bonded body is performed by inserting an eccentric pin P1 into the narrow hole HL1, and moving the bonded body YM1 or YM2 along the guide 111G (see FIG. 8) in the X or Y direction. Further, after the positional adjustment is performed, the eccentric pin P1 is removed and a screw is inserted into the fastening portion so that the first and second bonded bodies are fixed to the base body.

Furthermore, as shown in Part (a) of FIG. 11, the X or Y stage driving mechanism is provided with the first sub-yoke Y13 or the second sub-yoke Y23. This first or second sub-yoke is a member that has a width smaller than the first yoke Y11 or the second yoke Y21 in the X or Y direction. This first or second yoke is a member that has a width larger than the first magnet MG1 or the second magnet MG2 in the X or Y direction. The first bonded body YM1 or the second bonded body YM2 is fixed to the backside of the first yoke Y11 or the second yoke Y21 as seen from the first magnet MG1 or the second magnet MG2 at a position facing the first magnet MG1 or the second magnet MG2. The sub-yokes Y13 and Y23 are provided at positions capable of covering the ranges (see Part (c) of FIG. 11) where the polarities of the magnets MG1 and MG2 are changed. In this case, if the first and second yokes are thick, the size of the yoke is increased. For this reason, the yokes are made thin, and the first and second sub-yokes Y13 and Y23 are provided only at necessary positions. Therefore, the voice coil motor can be mounted in a small space. Further, the leakage of magnetic flux of a magnetic circuit, which is formed by the magnets MG1 and MG2 and the yokes Y11 to Y13 and Y21 to Y23, is reduced by the sub-yokes, so that it is possible to further efficiently apply a magnetic force to the coil.

In addition, as shown in Parts (c) and (d) of FIG. 11, magnets having two poles (S and N poles) are alternately provided in the magnet of the voice coil motor of this embodiment. When each of the stages is positioned in the middle of the stroke thereof, the position of each bonded body is adjusted so that the hall elements h1 and h2 approach a position (indicated by reference character BD1 in the drawing) facing a boundary between the N pole and the S pole. Meanwhile, the coil boards 1131A and 1131B are moved only within a range where the hall elements h1 and h2 face the S pole and the N pole that are positioned on the upper and lower sides of the boundary BD1 of the magnet, respectively.

The change in the output of the hall element while the bonded body is moved during the adjustment is illustrated in FIG. 12.

For example, while the output of the hall element is electrically monitored, the bonded bodies YM1 and YM2 are moved in one direction in order to detect the maximum output of the hall element. If the maximum output is detected, the bonded bodies are then moved in an opposite direction in order to detect the minimum output of the hall element. If both outputs are obtained and the bonded body is moved to a position where a value obtained by dividing the value of each of the outputs by 2 is obtained, the adjustment is performed so that each of the hall elements h1 and h2 exactly comes to a position (boundary indicated by reference character BD1 in FIG. 11) facing the boundary between the N pole and the S pole of each of the magnets MG1 and MG2.

If the adjustment is performed as described above, even though the coil board is actually moved so as to correspond to the maximum stroke, the output of the hall element is linearly obtained (linearity) in accordance with the change of the position without the saturation of the output of the hall element. Therefore, an accuracy in detecting the position is significantly improved.

In this way, the voice coil motor is densely mounted in a smaller space as compared to the conventional technique while maintaining a driving force comparable to that obtained by the conventional technique.

Returning to the original point, the structure of the XY stage will be described hereinafter with reference to FIGS. 9 and 10.

FIG. 9 is a Y cross-sectional view showing a cross section taken along a line that is represented by reference character R of FIG. 5. FIG. 10 is a bottom view of FIG. 5.

FIG. 9 is the same as FIG. 6. However, since FIGS. 9 and 6 are seen in different directions, the zoom motor ZM is only shown in FIG. 9. Further, FIG. 10 is the same as FIG. 8, and shows the structure of the X stage driving mechanism. It can be seen that the first bending portion FPC3 of the flexible board FPC is efficiently mounted in a small space like in FIG. 8.

The XY stage 110 is mounted to the lens barrel 100 in this way, so that the image-taking apparatus 1 of FIG. 1 is formed.

Since the alignment of four guide shafts needed to be individually adjusted in the conventional techniques, there was a problem in that it was difficult to perform assembly. In this embodiment, each of the X stage, the Y stage, and the CCD holder is supported at three points as described above, so that the alignment does not need to be adjusted. As a result, the assembly is simplified.

How easily the XY stage according to this embodiment is assembled will be described with reference to FIG. 5 again.

Further, as shown in FIG. 5, the X and Y stages 113A and 113B are provided to surround the central axis. Each of the guide shafts is fitted to the U-shaped groove formed on the base body, so that the stages 113A and 113B are supported by the base body. When the base body is manufactured, accurate squareness and parallelism are easily obtained. Accordingly, U-shaped grooves having squareness and parallelism are formed on the base body in advance and the guide shafts and the support shaft are fitted to the U-shaped grooves so that the squareness and parallelism of each of the shafts can be easily obtained. Therefore, the alignment of the shafts does not need to be individually adjusted unlike in the conventional techniques.

In this way, both ends of the first guide shaft G1, which is inserted into the two bearings A1 and A2 provided in the X stage, are fitted to the grooves. Further, the first support shaft G2 protruding in the X direction with respect to the first guide shaft G1 is also fitted to the grooves. When the X stage 113A is supported by the base body 111 at three points, that is, the bearings A1 and A2 and the support shaft G2 in this way, the X stage 113A is supported by the base body with high flatness.

Likewise, both ends of the fourth guide shaft G4, which is inserted into the two bearings A3 and A4 provided in the Y stage 113B, are fitted to the grooves. Further, the second support shaft G5 protruding in the Y direction with respect to the fourth guide shaft G4 is also fitted to the grooves. When the Y stage is supported by the base body at three points, that is, the bearings A3 and A4 and the support shaft G5 in this way, the Y stage 113B is supported by the base body 111 with high flatness.

When the flatness of the X and Y stages 113A and 113B are maintained with high accuracy, it is possible to make the CCD holder, which is the stage to be moved, precisely flat by supporting the CCD holder with these X and Y stages.

In addition, in the embodiment of FIG. 5, the Y stage 113B is provided with the second guide shaft G3, which extends in the X direction and is fixedly supported by the Y stage 113B. The CCD holder 112, which is the stage to be moved, is provided with the two bearings Bland B2 and one bearing B3. The bearings B1 and B2 are supported by the second guide shaft G3 so as to be restricted in the Y direction and freely slide in the X direction, and the bearing B3 is supported by the first guide shaft G1 not to be restricted in both X and Y directions. Therefore, the CCD holder 112 is supported at three points, that is, the two bearings B1 and B2 that are supported by the second guide shaft G3, and the bearing B3 that is supported by the first guide shaft G1, so that the attitude of the CCD holder with respect to the base body 111 is defined. As shown in the drawing, the bearings B1 and B2 are composed of bearings having corners in the Z and Y directions, and a U-shaped bearing is provided on the bearing B3. In addition, the CCD holder including the CCD plate and the like is biased toward the back of the drawing by the spring SP1 that is provided on the lid member 114. Therefore, the spring and the bearings specify the attitude of the member, which is to be moved, in the Z direction. For this reason, it is possible to obtain further high flatness.

In this way, when the CCD holder is interposed between two points on the Y stage having high flatness and one point on the X stage having high flatness so that the CCD holder is supported by three points, it is possible to obtain high flatness of the CCD holder.

Further, even when the same flatness with respect to the base body is achieved for the X stage, the Y stage, and the CCD holder due to the structure, if the backlashes of the bearing portions are increased, a backlash occurs while the CCD holder, which is a stage to be moved, the X stage, or the Y stage slides in one direction. For this reason, it is very likely that the movements of the X and Y stages as well as the CCD holder become slow.

In this embodiment, in order to eliminate occurrence of backlashes that occur during the sliding of the X and Y stages as described above, a backlash occurring during the sliding of the CCD holder, which is a stage to be moved, is reduced as much as possible by using the lid member 114 and the spring SPI provided in the lid member 114 and the shapes of the bearings.

As described above, the base body includes the two first support portions BE1 and BE2, two second support portions BE3 and BE4, third support portion BE5, and fourth support portion BE6. The first support portions BE1 and BE2 fixedly support both ends of the first guide shaft G1, and each have the shape of a U groove opened toward the lid member 114. The second support portions BE3 and BE4 fixedly support both ends of the fourth guide shaft G4, and each have the shape of a U groove opened toward the lid member 114. The third support portion BE5 supports the first support shaft G2 so that the first support shaft freely slides in the X direction, and has the shape of a U groove opened toward the lid member 114. The fourth support portion BE6 supports the second support shaft G5 so that the second support shaft freely slides in the Y direction, and has the shape of a U groove opened toward the lid member 114.

Furthermore, in connection with that, the lid member 114 includes the two first pressing portions, two second pressing portions, first blocking pieces, and second blocking pieces. The first pressing portions press the portions of the first guide shaft G1 that are supported by the two first support portions BE1 and BE2, respectively. The second pressing portions press the portions of the fourth guide shaft G4 that are supported by the two second support portions BE3 and BE4, respectively. The first blocking piece blocks the opening, which is opened toward the lid member 114, of the third support portion BE5, and forms the first supporting hole 114B into which the first support shaft G2 is inserted, together with the third support portion BE5. The second blocking piece blocks the opening, which is opened toward the lid member 114, of the fourth support portion BE6, and forms the second supporting hole 114B into which the second support shaft G5 is inserted, together with the fourth support portion BE6.

The lid member 114 is provided on the frontside of the plane of FIG. 5, that is, so as to cover the X and Y stages 113A and 113B and the stage (CCD holder) 112, which is to be moved, in the Z direction. Further, the bearings are formed by the lid member 114 and the base body 111.

To show such a configuration, the structure of each of the support portions BE1 to BE6 is extracted and shown in FIG. 5.

Since the first and second pressing portions have the same structure, one of the two second support portions BE3 and BE4 of the fourth guide shaft G4 is shown in FIG. 5. As shown in the enlarged view of FIG. 5, the guide shaft G4 is fitted into the U grooves, and is elastically pressed by the pressing portions 114A of the lid member 114 that are formed of steps at ends. When the first and fourth guide shafts are supported by the first and second support portions in this way, the first and fourth guide shafts G1 and G4 are fixedly supported by the base body 111.

In addition, since the third and fourth support portions BE5 and BE6 have the same structure and the first and the second blocking pieces have the same structure, only the third support portion BE5 and the first blocking piece are shown in the enlarged view of FIG. 5. As shown in this view, the U grooves are blocked by the blocking pieces of the lid member 114, so that the supporting holes 114B are formed. If the first and second support shafts G2 and G5 pass through the supporting holes 114B so as to be slidably supported, each of the X and Y stages 113A and 113B is supported by the base body 111 so as to smoothly slide.

Further, the connection portions between each of the stages 113A and 113B and the CCD holder 112 that is a stage to be moved has been contrived. In this example, the shape of each of the bearing portions B1, B2, and B3 that correspond to the three points has been contrived so that the CCD holder 112 is supported at three points to responsively move according to the movement of the X and Y stages 113A and 113B.

As described above, the CCD holder 112 is supported at the three points, that is, three bearings B1 and B2 and one bearing B3. The bearings B1 and B2 are supported by the second guide shaft G3, which extends in the X direction and is fixedly supported by the Y stage 113B, so as to be restricted in the Y direction and freely slide in the X direction. The bearing B3 is supported by the first guide shaft G1 not to be restricted in both X and Y directions. Therefore, the attitude of the CCD holder 112 with respect to the base body 111 is defined.

Further, with the fact that the CCD holder 112 is biased toward the backside of the plane of the drawing by the spring SP1 provided on the lid member 114, the bearing B3 of the CCD holder 112 supported by the first guide shaft G1 is opened in the Y direction so as to form a bearing, which has the shape of a U groove with the first guide shaft G1 therein, so that the guide shaft is biased against one side of the U groove and the attitude of the CCD holder 112 in the Z direction is thus defined. Furthermore, rectangular through holes through which the second guide shaft G3 passes are formed at the two bearings B1 and B2, respectively, of the CCD holder 112 that are supported by the second guide shaft G3. The rectangular through hole has corners in the Z and Y directions. The CCD holder is supported so as to be biased against one side of the rectangular through hole, so that the backlash in the Y direction is absorbed during the movement of the CCD holder.

In addition, a bearing portion B4 of the CCD holder 112, which is supported by the third guide shaft G6, is opened in the Z direction so as to form a bearing that has the shape of a U groove with the third guide shaft G6 therein. Accordingly, the CCD holder 112 is supported so that the third guide shaft G6 is always positioned in the U groove, is not restricted in the Z direction and restricted in the X direction.

As described above, the CCD holder 112 is pressed in the X direction by the spring SP2. Therefore, the third guide shaft G6 is pressed to one side of the U groove of the bearing portion B4, which absorbs looseness in the X direction at the time when the CCD holder 112 is moving.

The bearing portion B4 is provided at a position where moments applied from the guide shafts G1 and G3 to the CCD holder 112, while the CCD holder 112 slides in the X direction along the first and third guide shafts G1 and G3, are exactly offset each other. Accordingly, the CCD holder 112 moves smoothly in the X direction.

In this way, the backlashes in the X and Y directions are absorbed, and the attitude of the CCD holder, which is a stage to be moved, in the Z direction can be always maintained even during the slide, thereby forming the XY stage that ensures the smooth and quick reaction of the CCD holder 112.

As described above, according to the XY stage of the present invention, it is possible to realize an XY stage that is easily assembled while achieving flatness and has low manufacturing cost, and an image-taking apparatus including the XY stage.

Further, it is possible to realize an XY stage that hardly generates an unnecessary force such as friction and can responsively move a CCD holder along with the movement of a stage.

What is claimed is:

1. An XY stage that includes a base body, and a stage to be moved relative to the base body in an X-Y plane perpendicular to a central axis passing through the base body in a Z direction, the XY stage comprising:
an X stage that surrounds a half of the periphery of the central axis, is supported by the base body so as to freely slide in an X direction, supports the stage to be moved so that the stage to be moved is restricted in the X direction and freely slides in a Y direction, and moves the stage to be moved in the X direction by sliding in the X direction; and
a Y stage that surrounds the entire periphery of the central axis together with the X stage by surrounding a half of the periphery of the central axis, is supported by the base body so as to freely slide in the Y direction, supports the stage to be moved so that the stage to be moved is restricted in the Y direction and freely slides in the X direction, and moves the stage to be moved in the Y direction by sliding in the Y direction,
wherein the X stage is supported at three points by the base body so as to freely slide in the X direction, so that the attitude of the X stage with respect to the base body is defined,
the Y stage is supported at three points by the base body so as to freely slide in the Y direction, so that the attitude of the Y stage with respect to the base body is defined, and
the X and Y stages support the stage to be moved at three points, so that the attitude of the stage to be moved with respect to the base body is defined.

2. The XY stage according to claim 1, further comprising:
a first guide shaft that extends in the X direction and is fixedly supported by the base body,
wherein the X stage includes two bearings that are supported by the first guide shaft so as to be restricted in the Y direction and freely slide in the X direction, and a first support shaft that protrudes in the X direction and is supported by the base body so as to freely slide in the X direction, and
the X stage is supported at three points, that is, the two bearings supported by the first guide shaft and the first support shaft supported by the base body, so that the attitude of the X stage with respect to the base body is defined.

3. The XY stage according to claim 2, further comprising:
a second guide shaft that extends in the X direction and is fixedly supported by the Y stage,
wherein the stage to be moved includes two bearings that are supported by the second guide shaft so as to be restricted in the Y direction and freely slide in the X direction, and one bearing that is supported by the first guide shaft not to be restricted in both X and Y directions, and
the stage to be moved is supported at three points, that is, the two bearings supported by the second guide shaft and the bearing supported by the first guide shaft, so that the attitude of the stage to be moved with respect to the base body is defined.

4. The XY stage according to claim 3, wherein the bearing of the stage to be moved, which is supported by the first guide shaft, is opened in the Y direction to have the shape of a U groove with the first guide shaft therein.

5. The XY stage according to claim 3, further comprising:
a third guide shaft that extends in the Y direction and is fixedly supported by the X stage,
wherein the stage to be moved includes a bearing which is supported by the third guide shaft so as to be restricted in the X direction and freely slide in the Y direction, and which is supported not to be restricted, for defining the attitude of the stage to be moved.

6. The XY stage according to claim 5, wherein the bearing of the stage to be moved, which is supported by the third guide shaft, is opened in the Z direction to have the shape of a U groove with the third guide shaft therein.

7. The XY stage according to claim 5, further comprising:
a fourth guide shaft that extends in the Y direction and is fixedly supported by the base body,
wherein the Y stage includes two bearings that are supported by the fourth guide shaft so as to be restricted in the X direction and freely slide in the Y direction, and a second support shaft that protrudes in the Y direction and is supported by the base body so as to freely slide in the Y direction, and
the Y stage is supported at three points, that is, the two bearings supported by the fourth guide shaft and the second support shaft supported by the base body, so that the attitude of the Y stage with respect to the base body is defined.

8. The XY stage according to claim 7, further comprising:
a lid member that covers, from the Z direction, the X and Y stages and the stage to be moved,
wherein the base body includes:
two first support portions that fixedly support both ends of the first guide shaft, and each have the shape of a U groove opened toward the lid member;
two second support portions that fixedly support both ends of the fourth guide shaft, and each have the shape of a U groove opened toward the lid member;
a third support portion that supports the first support shaft so that the first support shaft freely slides in the X direction, and has the shape of a U groove opened toward the lid member; and
a fourth support portion that supports the second support shaft so that the second support shaft freely slides in the Y direction, and has the shape of a U groove opened toward the lid member, and
the lid member includes:
two first pressing portions that press the portions of the first guide shaft supported by the two first support portions, respectively;
two second pressing portions that press the portions of the fourth guide shaft supported by the two second support portions, respectively;
a first blocking piece that blocks an opening, which is opened toward the lid member, of the third support portion, and forms a first supporting hole into which the first support shaft is inserted, together with the third support portion; and
a second blocking piece that blocks an opening, which faces the lid member, of the fourth support portion, and forms a second supporting hole into which the second support shaft is inserted, together with the fourth support portion.

9. The XY stage according to claim 8, further comprising:
a first biasing member that is fixed to the lid member and biases the stage to be moved in the Z direction,
wherein the two bearings of the stage to be moved that are supported by the second guide shaft have rectangular through holes through which the second guide shaft passes having corners in the Z and Y directions, respectively.

10. The XY stage according to claim 1, further comprising:
a first magnet that is fixed to the base body; and
a first coil board that includes a first coil, the first coil board being fixed to the X stage and generating a force for moving the X stage in the X direction by an interaction between itself and the first magnet when being supplied with current.

11. The XY stage according to claim 1, further comprising:
a second magnet that is fixed to the base body; and
a second coil board that includes a second coil, the second coil board being fixed to the Y stage and generating a force for moving the Y stage in the Y direction by an interaction between itself and the second magnet when being supplied with current.

12. The XY stage according to claim 1, further comprising:
a second biasing member that biases the stage to be moved against the X stage in the X direction.

13. The XY stage according to claim 1, further comprising:
an imaging device that is fixed to the stage to be moved, and outputs an image signal representing an object upon formation of an image of the object.

14. An image-taking apparatus comprising:
the XY stage according to claim 13;
an image-taking lens that forms an image of an object on the imaging device; and
a drive section that drives the XY stage so as to correct blurring of the image represented by an image signal output by the imaging device.
